(19) United States
(12) Patent Application Publication
(10) Pub. No.: US 2023/0102001 A1
(43) Pub. Date: Mar. 30, 2023

(54) SYSTEMS AND METHODS FOR DISPENSING FLUID FROM A RUPTURABLE CELL

(71) Applicants: Charles Lancelot, Milton, GA (US); Christy Martin, Dawsonville, GA (US)

(72) Inventors: Charles Lancelot, Milton, GA (US); Christy Martin, Dawsonville, GA (US); James F. Schurman, Watch Hill, RI (US)

(21) Appl. No.: 17/908,595

(22) PCT Filed: Mar. 5, 2021
(86) PCT No.: PCT/US2021/021092

§ 371 Date: Sep. 1, 2022

Related U.S. Application Data
(60) Provisional application No. 62/986,186, filed on Mar. 6, 2020.

(51) Int. Cl. A47K 7/03; B08B 3/08; B08B 1/00; A45D 29/00; A45D 34/04

(52) U.S. Cl. CPC A47K 7/03; B08B 3/08; B08B 1/006; A45D 29/007; A45D 34/04

(57) ABSTRACT

The present disclosure relates to a fluid delivery system that includes a surface contact a layer and a matrix of rupturable cells. The rupturable cells contain fluid confined with the cell. The fluid is absorbed by the surface contact layer when at least one of the cells is ruptured.

### CROSS-REFERENCES TO RELATED APPLICATIONS

This application is based on and claims priority to U.S. Patent Application No. 62/986,186 filed Mar. 6, 2020, which is hereby incorporated by reference herein in its entirety for all purposes.

### STATEMENT REGARDING FEDERALLY SPONSORED RESEARCH

Not Applicable.

### BACKGROUND OF THE INVENTION

### 1. Field of the Invention

This invention relates to dispensing devices, such as a flexible matrix for dispensing a fluid medium onto a surface. In particular, this invention relates to dispensing commercial, institutional, and personal care media to a surface in order to remove undesired or accumulated materials from the surface or to apply desired materials to the surface. This invention also relates to methods for making such devices.

### 2. Description of the Related Art

Removal of oils, grease, old paint, tarnish, nail polish and the like from surfaces often involves using a medium such as cloth, sponge, paper towel, cotton and the like, that is dipped, soaked or otherwise saturated with a suitable solvent and applying directly to the surface in a rubbing motion to remove the undesired unwanted material or materials from the surface. Wipes and cloths individually wrapped and pre-soaked with suitable solvents are also currently available that are meant to be used in a rubbing motion to remove unwanted materials from a surface. Another in-home and/or commercial method of removal is to soak the objects directly with suitable solvents for a period of time to help lessen the time of physically removing the unwanted materials. In general, this method of removal is highly undesirable in that the user is exposed to the hazards of solvents and chemical vapors. Such chemicals and vapors can cause harmful dermal, respiratory, and other effects when used in excessive amounts. Protective gloves and adequate ventilation are often recommended for protection against such harmful effects.

Most or all of the same dispensing methods described above for surface material removal are also commonly employed for the application of a paste, cream or liquid to a target surface to impart certain desired properties to said surface or otherwise achieve a desired effect on said surface. Some examples in the personal care sector may include application of any of many topical care agents, such as deodorants, antiseptics or other wound treatments, colorants, bleaches, and the like. In the institutional and commercial sector, some examples include application of surface coatings, polishes, surface sanitation and disinfection agents and bleaches, oils and other protective coatings, waxes, and the like. In some cases, the application of the surface treatment agent is accompanied or followed by a rubbing action to optimize penetration and surface appearance. Here also, these methods of applying a substance to a surface may be highly undesirable in cases where the user is exposed to the hazards of bulk liquids, solvents, and chemical vapors, as well as potentially harmful dermal, respiratory, and other effects of the excessive amounts of certain chemical pastes, creams, or liquids used. Protective gloves and adequate ventilation are sometimes recommended for protection against such harmful effects.

Therefore, what is needed is an improved system and method for dispensing a fluid material, and, in particular, for removing unwanted materials from surfaces and/or for applying desired materials and/or coatings to surfaces.

### SUMMARY OF THE INVENTION

In one aspect, the present disclosure provides a fluid delivery system that can include a surface contact layer and a matrix of rupturable cells. The cells in the matrix of rupturable cells can contain a fluid confined within the cell. The fluid can be absorbed by the surface contact layer when at least one of the cells is ruptured.

In some embodiments, the matrix of rupturable cells can comprise foam. In other embodiments, the matrix of rupturable cells can comprise a closed-cell foam. In another embodiment, the matrix of rupturable cells can be formed by a flexible film, such as a thermoplastic. In other embodiments, the flexible film can include polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

In some embodiments, the surface contact layer may be a fibrous material. Specifically, the surface contact layer may be a material selected from the group consisting of woven or non-woven polyethylene, polypropylene, cotton, polyester, polyurethane, polyamide, wool, sponge and mixtures thereof. The surface contact layer may have a thickness between about 0.3 millimeters to 12.7 millimeters.

In some embodiments, without limit, the fluid may be selected from the group consisting of institutional, commercial and/or consumer cleaners, disinfectants and/or sanitizers, paint removers, surface strippers and cleaners, tarnish removers, nail polish removers, insect repellents, edible materials, cleansers, antiperspirants, deodorants, skin care fluids, sunscreen, and the like. Surface material removers may be selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof. The selected cellular matrix must be inert to and impenetrable by any selected cell contents in order to prevent any premature penetration or loss of the cell contents. In some embodiments, the fluid can include at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid can include quaternary ammonium cations.

In some embodiments, each cell of the matrix of rupturable cells may include a marker to indicate a position whereupon a force is required to rupture one of the cells. In some embodiments, the surface contact layer can include abrasive properties. For example, the surface contact layer may include an intrinsically abrasive material or a material rendered abrasive or additionally abrasive by the inclusion of substances selected from the group consisting of metallic particles, minerals, plastics, and mixtures thereof.

In some embodiments, the fluid delivery system can be a flexible sheet and can be configured to be wound into a rolled orientation or to be stacked and packaged in a box or similar enclosure optionally provided with a means of easily dispensing individual sheets. In other embodiments, the flexible sheet can include lines of material weakness for separating segments of the flexible sheet without rupturing any of the cells of the matrix of rupturable cells. The lines of material weakness may include perforations.

In some embodiments, a volume of fluid confined within each cell of the matrix of rupturable cells can be within the range of approximately 0.1 milliliters to approximately 2.0 milliliters. In some embodiments, the diameter of each cell of the matrix of rupturable cells can be within a range of approximately 0.2 millimeters to 25 millimeters. A space between each cell of the matrix of rupturable cells may be between about 1 millimeter and 3 millimeters. In one embodiment, each cell of the matrix of rupturable cells are uniformly spaced.

In another aspect, the present disclosure provides a fluid delivery system. The fluid delivery system can include a surface contact layer, a first film, and a second film. The first and second films can form a matrix of rupturable cells. The rupturable cells can contain a fluid confined within the cell. The fluid can be absorbed by the surface contact layer when at least one of the cells is ruptured.

In some embodiments, the matrix of rupturable cells can include a flexible film. The flexible film can include polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the surface contact layer can be a fibrous material. The surface contact layer can include material selected from the group consisting of woven or non-woven polyethylene, polypropylene, cotton, polyester, polyamide, polyurethane, wool, sponge, and mixtures thereof. The surface contact layer can have a thickness between 0.3 millimeters and 12.7 millimeters.

In some embodiments, the fluid in the fluid delivery system can be selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

In some embodiments, the fluid in the fluid delivery system can be selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

In some embodiments, each cell of the matrix of rupturable cells can include a marker to indicate a position whereupon a force is required to rupture one of the cells. In some embodiments, the surface contact layer can be abrasive. The surface contact layer can be an intrinsically abrasive material or a material rendered abrasive or additionally abrasive the by inclusion of substances selected from the group consisting of metallic particles, minerals, plastics, and mixtures thereof.

In some embodiments, the fluid delivery system can be a flexible sheet. The flexible sheet can include lines of material weakness for separating segments of the flexible sheet without rupturing any of the cells of the matrix of rupturable cells. The lines of material weakness can include perforations.

In some embodiments, the volume of the fluid confined within each cell of the rupturable cells can be in the range of 0.1 milliliters to 10 milliliters. A diameter of each cell of the matrix of rupturable cells can be in the range of 1 millimeters to 25 millimeters. A space between each cell of the matrix of rupturable cells can be in a range of 1 millimeter to 8 millimeters. Each cell of the matrix of rupturable cells can be uniformly spaced.

In another aspect, the present disclosure provides a fluid delivery system. The fluid delivery system can include a surface contact layer having abrasive properties and a matrix of rupturable cells. The cells of the matrix of rupturable cells can contain a fluid confined within the cell. The fluid can be absorbed by the surface contact layer when at least one cell is ruptured.

In some embodiments, the surface contact layer can include an intrinsically abrasive material or a material rendered abrasive or additionally abrasive by the inclusion of substances selected from the group consisting of metallic particles, minerals, plastics, and mixtures thereof. The surface contact layer can include an absorbent layer and an abrasive layer.

In some embodiments, the matrix of rupturable cells can include a flexible film. The flexible film can include a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the surface contact layer can include a fibrous material. The surface contact layer can include a material selected from the group consisting of woven or non-woven polyethylene, polypropylene, cotton, polyester, polyamide, polyurethane, wool, sponge, and mixtures thereof. The surface contact layer can have a thickness in a range of 0.3 millimeters to 12.7 millimeters.

In some embodiments, the fluid can be selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

In some embodiments, the fluid can be selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

In some embodiments, each cell of the matrix of rupturable cells can include a marker to indicate a position whereupon a force is required to rupture one of the cells. The surface contact layer can include a scrubbing surface. The surface contact layer can include an intrinsically abrasive material or a material rendered abrasive or additionally abrasive by the inclusion of substances selected from the group consisting of metallic particles, minerals, plastics, and mixtures thereof.

In some embodiments, the fluid delivery system can be configured as a flexible sheet. The flexible sheet can include lines of material weakness for separating segments of the flexible sheet without rupturing any of the cells of the matrix of rupturable cells. The lines of material weakness can include perforations.

In some embodiments, a volume of the fluid confined within each cell can be within the range of 0.1 milliliters to 10 milliliters. A diameter of each cell can be in a range of 1.0 millimeters to 25 millimeters. A space between each cell of the matrix of cells can be i the range of 1 millimeter to 8 millimeters. Each of the cells can be uniformly spaced.

In another aspect, the present disclosure provides a fluid delivery system that includes a flexible film, a surface contact layer, and a plurality of rupturable cells. The cells can be positioned between the flexible film and the surface contact layer, each cell containing a fluid confined within the cell and being absorbed by the surface contact layer when at least one of the plurality of cells is ruptured.

In some embodiments, the film can be impermeable to the fluid contained therein. The film can include a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the surface contact layer can be a fibrous material. The surface contact layer can include a material selected from the group consisting of woven or non-woven polyethylene, polypropylene, cotton, polyester, polyamide, polyurethane, wool, sponge, and mixtures thereof. The surface contact layer can have a thickness in a range of 0.3 millimeters to 12.7 millimeters.

In some embodiments, the plurality of cells can include polyolefin. The fluid can be selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

In some embodiments, the fluid can be selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

In some embodiments, the film can include a marker to indicate a position whereupon a force is required to rupture one of the plurality of cells. The surface contact layer can include a scrubbing surface. The surface contact layer can include an intrinsically abrasive material or a material rendered abrasive or additionally abrasive by the inclusion of substances selected from the group consisting of metallic particles, minerals, plastics, and mixtures thereof.

In some embodiments, the fluid delivery system can be a flexible sheet. The flexible sheet can include lines of material weakness for separating segments of the flexible sheet without rupturing any of the plurality of cells. The lines of material weakness can include perforations.

In some embodiments, the fluid delivery system can include an absorbent layer adjacent to the plurality of rupturable cells. A volume of the fluid confined within each of the plurality of cells can be in a range of 0.1 milliliters to 10 milliliters. A diameter of each of the plurality of cells can be in a range of 1.0 millimeters to 25 millimeters. A space between each of the plurality of cells can be in a range of 1 millimeter to 8 millimeters. Each of the plurality of cells can be uniformly spaced. Each of the plurality of cells can be arranged in a matrix.

In another aspect, the present disclosure provides a method of manufacturing a fluid delivery system. The method can include bonding a surface contact layer sheet to a side of a sheet of cells, creating an opening in individual cells using a needle, injecting a fluid through the opening in individual cells using the needle, and removing the needle from the opening in each injected cell such that the opening closes, thereby preventing escape of the contained fluid. In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the needle may be a heated needle. The method of manufacturing a fluid delivery system may further include creating an opening in the individual cells using at least one heated needle per cell of a matrix of heated needles, injecting a fluid through the opening in individual cells using at least one heated needle of the matrix of heated needles per cell, and removing the heated needle of the matrix of heated needles from the opening in each injected cell such that heat from the heated needle of the matrix of heated needles closes the opening, thereby preventing escape of the contained fluid.

In another aspect, the present disclosure provides a method of manufacturing a fluid delivery system. The method can include bonding a first sheet of a flexible material to a second sheet of a flexible material to form a matrix of cells, bonding a surface contact layer sheet to the second sheet, creating an opening in individual cells using a needle, injecting a fluid through the opening in individual cells using the needle, and removing the needle from the opening in each injected cell such that the opening closes, thereby preventing escape of the fluid that is contained. In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the needle can be a heated needle. The method can include passing a heated needle through the surface contact layer sheet at the creating an opening step. The needle can be a single needle.

In some embodiments, the method can include creating an opening in individual cells using a single needle per cell of a matrix of heated needles. The method can include injecting a fluid through the opening in individual cells using one heated needle of the matrix of heated needles. The method can include removing the heated needle of the matrix of heated needles from the opening in each injected cell wherein heat from the heated needle of the matrix of heated needles closes the opening thereby preventing escape of the fluid that is contained. The flexible material can be thermoplastic.

In another aspect, the present disclosure provides a method of manufacturing a fluid delivery system. The method can include providing a matrix of rupturable cells, wherein the matrix of rupturable cells includes a foam. The method can also include introducing a fluid under a pressure into the matrix such that at least a portion of the cells contains the fluid. In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations.

In some embodiments, the pressure can be uniform across the surface of the matrix. In some embodiments, introducing the fluid under pressure can include inserting a heated needle into a cell of the matrix of the rupturable cells.

In another aspect, the present disclosure provides a method of manufacturing a fluid delivery system. The method can include providing a first film and a second film, at least the second film having curved sides that define a plurality of wells in the second film; introducing a fluid into each of the plurality of wells; laminating the first film to the second film such that the fluid remains contained within each cell of a plurality of cells created by the first film and the plurality of wells; and bonding a surface contact layer sheet to one side of the laminated films containing the fluid within each cell of the plurality of cells. In some embodiments, the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate. In some embodiments, the fluid comprises quaternary ammonium cations. In some embodiments, the fluid is introduced into the plurality of wells in liquid, gel, or similar form. In some embodiments, the fluid is introduced into each well of the plurality of wells in the form of an individual capsule containing the fluid. In some embodiments, the fluid contained in any capsule in a plurality of capsules in the plurality of wells may be identical to or may differ from the fluid contained in any other capsules in the plurality of capsules. In some embodiments, the first film and the second film and any individual fluid encapsulant introduced into the plurality of wells each comprise a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

These and other features, aspects, and advantages of the present invention will become better understood upon consideration of the following detailed description, drawings and appended claims.

### BRIEF DESCRIPTION OF THE DRAWINGS

FIG. 1 is a side view of a fluid delivery system according to an embodiment of the present disclosure.

FIG. 2 is a partial side view of the fluid delivery system of FIG. 1.

FIG. 3 is a top view of the fluid delivery system according to an embodiment of the present disclosure.

FIG. 4A is a side view of an empty fluid delivery system and a matrix of needles according to an embodiment of the present disclosure.

FIG. 4B is a side view of the empty fluid delivery system of FIG. 4A with the needle matrix inserted into a contact surface layer according to an embodiment of the present disclosure.

FIG. 4C is a side view of a fluid-containing fluid delivery system with the needle matrix inserted into the matrix of cells according to an embodiment of the present disclosure.

FIG. 4D is a side view of the fluid-containing fluid delivery system of FIG. 4C with the needle matrix removed from the fluid delivery system.

Like reference numerals will be used to refer to like parts from Figure to Figure in the following description of the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including”, “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

The term “about,” as used herein, refers to variation in the numerical quantity that may occur, for example, through typical measuring and manufacturing procedures used for fluid dispensing products or other products of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about” and “approximately” refer to a range of values ±5% of the numeric value that the term precedes.

The present invention discloses a fluid delivery system that includes a surface layer and a matrix of rupturable cells. The cells contain a fluid confined within the cell which can be absorbed by the surface contact layer when at least one of the cells is ruptured. The matrix of cells facilitates a single-use configuration such that an appropriate amount of fluid is released upon rupturing one or more cells. In general, an appropriate amount of fluid relates generally to an amount of fluid that is sufficient to complete a desired task. For example, if the rupturable cell contains nail-polish remover fluid, an appropriate amount of fluid can include enough nail-polish remover to sufficiently remove nail polish from a single finger.

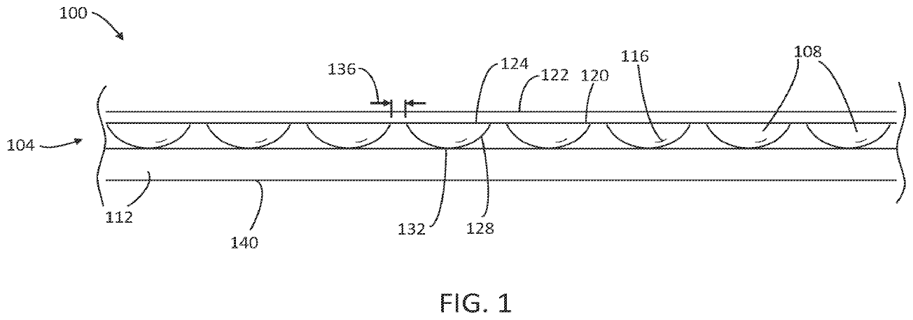

FIG. 1 illustrates a fluid delivery system 100 configured as a flexible sheet that has a matrix 104 of rupturable cells 108 and a surface contact layer 112. In the example shown, each of the rupturable cells 108 of the matrix 104 contains a fluid 116. The surface contact layer 112 is configured to at least partially absorb the fluid when one of the cells 108 is ruptured. In one embodiment, the fluid 116 is an alkylene carbonate-based oil-and-grease or nail polish remover; however, other configurations are possible. For example, the rupturable cells 108 may contain active bleach compositions such as aqueous hydrogen peroxide or stabilized hypochlorite and other sanitizers for domestic, commercial and institutional disinfection, the last including hospitals, doctors' offices and restaurants. Furthermore, the cells 108 may contain paint removers, hard surface strippers, hard surface cleaners, insect repellents, edible materials, industrial cleaners, deodorants, skin care fluids or gels, and the like.

In some embodiments, the cells 108 can contain one or more disinfectants known and proven to kill certain viruses. For example, the cells 108 can contain a disinfectant proven to kill the coronavirus SARS-CoV-2 (COVID-19). Such disinfectants can include quaternary ammonium cations (quats), isopropyl alcohol (e.g., 70% aqueous isopropyl alcohol), hydrogen peroxide, phenolic solutions, tetraacetylethylenediamine with a suitable peroxygen chemical, sodium hypochlorite, octanoic acid, iodine, sodium dichloroisocyanurate, and the like.

In the illustrated embodiment, the matrix 104 includes a first film 120 that forms a planar side 124 of each cell 108 and a second film 128 that forms a curved side 132 of each cell 108. In the embodiment shown, each of the first film 120 and the second film 128 is a flexible and rupturable material; however, other configurations and materials are possible. The cells 108 are impermeable to and inert to the fluid 116 contained therein, such that the fluid 116 remains contained with the cell 108 until the cell 108 is intentionally ruptured.

In additional embodiments, at least one of the first film 120 and the second film 128 may include one or more polymeric materials such as polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, etc. and mixtures thereof. Further, in other embodiments, a fluid delivery system may include a fluid containing material such as foam. In particular, the foam may be a closed-cell foam configured to contain any number of fluids, including those listed above. In the closed-cell foam embodiment, the fluid containing material may be impregnated with the fluid by introducing the fluid to the foam under a pressure, thereby creating a matrix of rupturable cells. In some embodiments, the pressure may be uniform across a surface of the matrix.

FIG. 1 further illustrates each of the rupturable cells 108 uniformly spaced across the matrix 104. As shown, the rupturable cells 108 are separated by a distance 136 that is approximately 2 millimeters. In other embodiments, the rupturable cells 108 may be separated between approximately 1 millimeters and approximately 3 millimeters, or between approximately 0.2 millimeter and approximately 8 millimeters. In other configurations, the rupturable cells 108 may be dispersed across the matrix 104 non-uniformly.

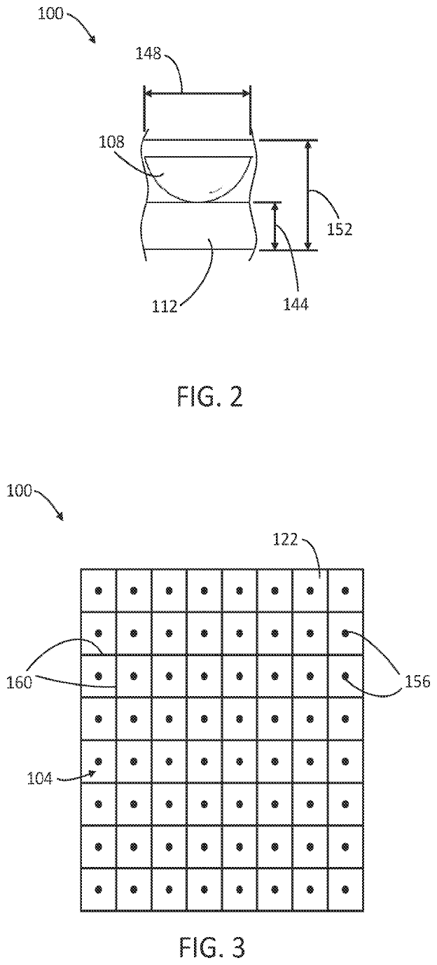

FIG. 2 illustrates a side view of a single rupturable cell 108 from the matrix 104 adjacent to the surface contact layer 112. In the illustrated embodiment, the matrix 104 is bonded to the surface contact layer 112 to form the fluid delivery system 100. In some embodiments, a fluid delivery system may include a matrix of rupturable cells that is adhered to a surface contact layer. In other embodiments, a fluid delivery system may include a matrix of rupturable cells that is integrally formed with a contact surface layer. In other embodiments, a fluid delivery system may include a matrix of rupturable cells that is fastened to a contact surface layer; however, other configurations are possible.

In one embodiment, the surface contact layer 112 includes a fibrous material 140. The fibrous material may be of either woven or nonwoven construction. In the illustrated embodiment, the fibrous material 140 includes cotton; however, other configurations are possible. For example, the surface contact layer 112 may include polyethylene, polypropylene, cotton, polyester, polyurethane, polyamide, wool, sponge, etc., and mixtures thereof. Additionally, the surface contact layer 112 can include abrasive properties and/or a scrubbing surface. For example, the surface contact layer 112 can additionally or alternatively include an intrinsically abrasive material or a material rendered abrasive or additionally abrasive by the inclusion of metallic particles, minerals, plastics, etc., and mixtures thereof. In additional or alternative embodiments, the surface contact layer 112 can include an absorbent layer.

In some embodiments, the fluid delivery system 100 can also include a pressure layer 122 that is distinct from the matrix 104 of rupturable cells 108. The pressure layer 122 can be configured to receive deliberate pressure such that one or more of the rupturable cells 108 ruptures and the fluid 116 is absorbed into the contact surface layer 140. The pressure layer 122 will also contribute to the prevention of accidental, undesired rupture of cells 108 directionally opposite the surface contact layer 112.

As illustrated in FIG. 2, the surface contact layer 112 has a thickness 144 that is approximately 1.2 millimeters. In other embodiments, the surface contact layer 112 can have a thickness 144 that is between approximately 0.7 millimeters and approximately 3 millimeters, or between approximately 0.5 millimeters and 5 millimeters. In other embodiments, the surface contact layer 112 may have a thickness 144 sufficient to absorb the fluid 116 when one or more cells 108 is ruptured and then apply the fluid 116 to an exterior surface, such as a part to be sanitized, or cleaned prior to finishing, or polished fingernails, for example. In the illustrated embodiment, each of the rupturable cells 108 contains approximately 0.25 milliliters of fluid 116; however, other configurations are possible. For example, each rupturable cell 108 may contain between approximately 0.1 milliliters and 1 milliliter of fluid 116, or between approximately 0 milliliters (empty) and 10 milliliters. Additionally, in the illustrated embodiment, the rupturable cell 108 has a diameter 148 that is approximately 10 millimeters; however, other configurations are possible. For example the diameter 148 can be between approximately 6 millimeters and approximately 16 millimeters, or between approximately 1 millimeter and approximately 28 millimeters.

In the aforementioned examples, a volume of fluid 116 from one or two cells and an appropriate amount of absorption and abrasiveness of the surface contact layer 112 is sufficient to remove nail polish from a fingernail with mild pressure and scrubbing, while a larger number of cells and a thicker surface contact layer will be sufficient to de-grease a larger part to be assembled or finished, or a surface to be sanitized.

Further illustrated in FIG. 2, the fluid delivery system 100 has an overall thickness 152 that is approximately 6.2 millimeters; however, other configurations are possible. For example, the overall thickness 152 can be between approximately 1.7 millimeters and approximately 12 millimeters, or between approximately 1 millimeter and approximately 18 millimeters. In general, the dimensions described above are by way of example and are in no way meant to be limiting.

Referring now to FIG. 3, the fluid delivery system 100 further includes a plurality of indicators 156 arranged on the planar side 124 of the cells 108. In the illustrated embodiment, the plurality of indicators 156 are arranged on the pressure layer 122 and correspond to each of the rupturable cells 108 in the matrix 104. While in the embodiment shown, the indicators 156 are configured as dots and are arranged on the planar side 124, other configurations are possible. In other embodiments, the indicators 156 may provide alternative sensory indication, for example, a raised surface that a user can physically locate with touch.

The fluid delivery system 100 further includes lines of material weakness 160. In the illustrated embodiment, the lines of material weakness 160 are configured as perforations such that segments of the fluid delivery system 100 can be separated without rupturing any cells 108. In some embodiments, each cell 108 may be within its own separable segment. In other embodiments, a plurality of cells 108 may be in a separable segment defined by the lines of material weakness 160. In other embodiments, the fluid delivery system 100 may not include lines of material weakness and may be configured as a single sheet.

In some embodiments, the fluid delivery system 100 may be flexible such that it can be folded on itself to rupture one or more cells 108, thereby eliminating the need to apply pressure to the fluid delivery system 100 in combination with a receiving surface, such as skin, for example. The surface contact layer 112 may then be moistened and the fluid 116 can be applied to the desired surface followed by any desired or required rubbing or scrubbing. This method of using the fluid delivery system 100 to self-rupture cells prevents unwanted pressure on, for example, soft or sensitive surfaces.

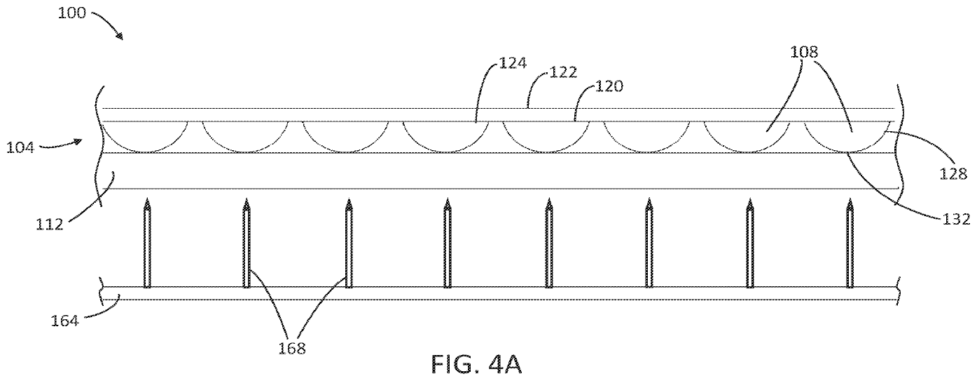

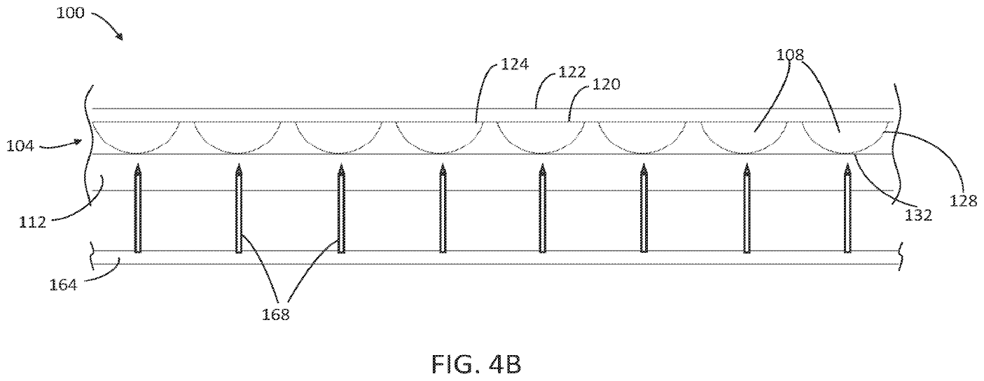

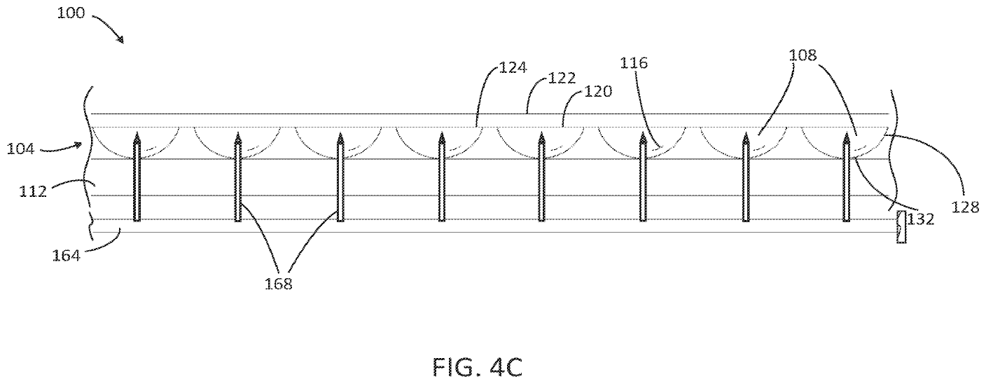

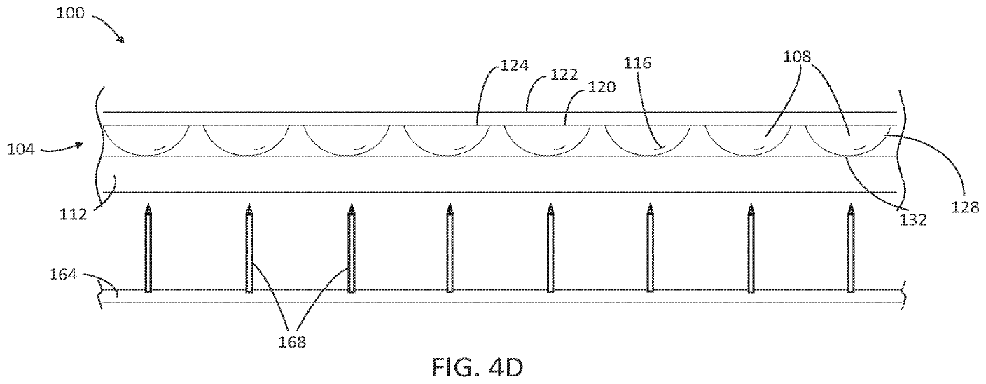

Referring now to FIGS. 4A-4D, a method of manufacturing the fluid delivery system 100 according to an embodiment is illustrated. The method includes bonding a surface contact layer 112 to a sheet of cells. In the illustrated embodiment, the sheet of cells is configured as the matrix 104; however, other configurations are possible, such as for example, single cells. The method further includes creating an opening in individual cells 108 using a matrix of needles 164 and injecting the fluid 116 into the cells 108. The matrix of needles 164 includes a plurality of heated needles 168, according to an embodiment. The method further includes removing the needle 168 from the injected cell 108 such that the opening closes and prevents any of the fluid 116 contained from escaping. While some embodiments can include a heated needle 168, other embodiments include another injection device, such as a non-heated needle. Additional embodiments may include a single needle configured to fill each cell of a matrix of cells. Further embodiments may include a plurality of needles configured to fill a single rupturable cell.

FIG. 4B illustrates each needle 168 of the matrix of needles 164 partially inserted through the surface contact layer 112. FIG. 4C further illustrates each needle 168 of the matrix of needles 164 extending through the surface contact layer 112 and through the second film 128 of the curved side 132 of the cell 108. When the needle is at least partially inserted into the cell 108, the fluid 116 may be injected. FIG. 4D illustrates the matrix of needles 164 fully removed from the fluid delivery system 100. Upon removal, each heated needle 168 sufficiently heats the second film 128 to create a seal such that cell 108 fully contains the fluid 116 without leakage.

Referring now to FIG. 1, in another embodiment of a method of manufacturing the fluid delivery system 100, the second film 128 that forms a curved side 132 of each cell 108 is provided. The curved sides 132 define a plurality of wells in the second film 128. The second film 128 is supported on a surface and the fluid 116 is injected into each of the plurality of wells in the second film 128. The first film 120 is then laminated to the second film 128 such that the fluid 116 remains contained within each cell 108 until the cell 108 is intentionally ruptured. A surface contact layer sheet 112 can be bonded to one side of the laminated films containing the fluid within each cell of the plurality of cells. In some embodiments of this method, the fluid is introduced into the plurality of wells in liquid, gel, or similar form. In some embodiments, the fluid is introduced into each well of the plurality of wells in the form of an individual capsule containing the fluid. In some embodiments, the fluid contained in any capsule in a plurality of capsules in the plurality of wells may be identical to or may differ from the fluid contained in any other capsules in the plurality of capsules. In some embodiments, the first film and the second film and any individual fluid encapsulant introduced into the plurality of wells each comprise a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

What is claimed is:

1. A fluid delivery system comprising:
a surface contact layer; and
a matrix of rupturable cells wherein the cells of the matrix of rupturable cells contain a fluid confined within the cell, the fluid being absorbed by the surface contact layer when at least one of the cells is ruptured.

2. The fluid delivery system of claim 1, wherein the matrix of rupturable cells comprises a foam.

3. The fluid delivery system of claim 1, wherein the matrix of rupturable cells comprises a closed-cell foam.

4. The fluid delivery system of claim 1, wherein the matrix of rupturable cells are formed by a flexible film.

5. The fluid delivery system of claim 4, wherein the flexible film comprises a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

6. The fluid delivery system of claim 1, wherein the surface contact layer is a fibrous material.

7. The fluid delivery system of claim 1, wherein the surface contact layer comprises a material selected from the group consisting of woven or non-woven polyethylene, polypropylene, cotton, polyester, polyurethane, polyamide, wool, sponge, and mixtures thereof.

8. The fluid delivery system of claim 1, wherein the surface contact layer has a thickness in a range of 0.3 millimeters to 12.7 millimeters.

9. The fluid delivery system of claim 1, wherein the fluid is selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

10. The fluid delivery system of claim 1, wherein the fluid is selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

11. The fluid delivery system of claim 1, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

12. The fluid delivery system of claim 1, wherein the fluid comprises quaternary ammonium cations.

13. The fluid delivery system of claim 1, wherein each cell of the matrix of rupturable cells includes a marker to indicate a position whereupon a force is required to rupture one of the cells.

14. The fluid delivery system of claim 1, wherein the surface contact layer possesses abrasive properties.

15. The fluid delivery system of claim 1, wherein the surface contact layer comprises an intrinsically abrasive material or a material rendered abrasive or additionally abrasive by the inclusion of substances selected from the group consisting of metallic particles, minerals, plastics, and mixtures thereof.

16. The fluid delivery system of claim 1, wherein the fluid delivery system is configured as a flexible sheet.

17. The fluid delivery system of claim 16, wherein the flexible sheet includes lines of material weakness for separating segments of the flexible sheet without rupturing any of the cells of the matrix of rupturable cells.

18. The fluid delivery system of claim 17, wherein the lines of material weakness comprises perforations.

19. The fluid delivery system of claim 1, wherein a volume of the fluid confined within each cell of the matrix of rupturable cells is in a range of 0.1 milliliters to 10 milliliters.

20. The fluid delivery system of claim 1, wherein a diameter of each cell of the matrix of rupturable cells is in a range of 1.0 millimeters to 25 millimeters.

21. The fluid delivery system of claim 1, wherein a space between each cell of the matrix of rupturable cells is in a range of 1 millimeter to 8 millimeters.

22. The fluid delivery system of claim 1, wherein each cell of the matrix of rupturable cells are uniformly spaced.

23. A fluid delivery system comprising:
a surface contact layer; and
a first film and a second film forming a matrix of rupturable cells wherein the cells of the matrix of rupturable cells contain a fluid confined within the cell, the fluid being absorbed by the surface contact layer when at least one of the cells is ruptured.

24. The fluid delivery system of claim 23, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

25. The fluid delivery system of claim 23, wherein the fluid comprises quaternary ammonium cations.

26. The fluid delivery system of claim 23, wherein the matrix of rupturable cells comprises a flexible film.

27. The fluid delivery system of claim 26, wherein the flexible film comprises a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

28. The fluid delivery system of claim 23, wherein the surface contact layer is a fibrous material.

29. The fluid delivery system of claim 23, wherein the surface contact layer comprises a material selected from the group consisting of woven or non-woven polyethylene, polypropylene, cotton, polyester, polyamide, polyurethane, wool, sponge, and mixtures thereof.

30. The fluid delivery system of claim 23, wherein the surface contact layer has a thickness in a range of 0.3 millimeters to 12.7 millimeters.

31. The fluid delivery system of claim 23, wherein the fluid is selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

32. The fluid delivery system of claim 23, wherein the fluid is selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

33. The fluid delivery system of claim 23, wherein each cell of the matrix of rupturable cells includes a marker to indicate a position whereupon a force is required to rupture one of the cells.

34. The fluid delivery system of claim 23, wherein the surface contact layer possesses abrasive properties.

35. The fluid delivery system of claim 23, wherein the surface contact layer comprises an intrinsically abrasive material or a material rendered abrasive or additionally abrasive by the inclusion of substances selected from the group consisting of metallic particles, minerals, plastics, and mixtures thereof.

36. The fluid delivery system of claim 23, wherein the fluid delivery system is configured as a flexible sheet.

37. The fluid delivery system of claim 36, wherein the flexible sheet includes lines of material weakness for separating segments of the flexible sheet without rupturing any of the cells of the matrix of rupturable cells.

38. The fluid delivery system of claim 37, wherein the lines of material weakness comprises perforations.

39. The fluid delivery system of claim 23, wherein a volume of the fluid confined within each cell of the matrix of rupturable cells is in a range of 0.1 milliliters to 10 milliliters.

40. The fluid delivery system of claim 23, wherein a diameter of each cell of the matrix of rupturable cells is in a range of 1.0 millimeters to 25 millimeters.

41. The fluid delivery system of claim 23, wherein a space between each cell of the matrix of rupturable cells is in a range of 1 millimeter to 8 millimeters.

42. The fluid delivery system of claim 23, wherein each cell of the matrix of rupturable cells are uniformly spaced.

43. A fluid delivery system comprising:
a surface contact layer possessing abrasive properties; and
a matrix of rupturable cells wherein the cells of the matrix of rupturable cells contain a fluid confined within the cell, the fluid being absorbed by the surface contact layer when at least one of the cells is ruptured.

44. The fluid delivery system of claim 43, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

45. The fluid delivery system of claim 43, wherein the fluid comprises quaternary ammonium cations.

46. The fluid delivery system of claim 43, wherein the surface contact layer comprises an intrinsically abrasive material or a material rendered abrasive or additionally abrasive by the inclusion of substances selected from the group consisting of metallic particles, minerals, plastics, and mixtures thereof.

47. The fluid delivery system of claim 43, wherein the surface contact layer comprises an absorbent layer and an abrasive layer.

48. The fluid delivery system of claim 43, wherein the matrix of rupturable cells comprises a flexible film.

49. The fluid delivery system of claim 48, wherein the flexible film comprises a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

50. The fluid delivery system of claim 43, wherein the surface contact layer is a fibrous material.

51. The fluid delivery system of claim 43, wherein the surface contact layer comprises a material selected from the group consisting of woven or non-woven polyethylene, polypropylene, cotton, polyester, polyamide, polyurethane, wool, sponge, and mixtures thereof.

52. The fluid delivery system of claim 43, wherein the surface contact layer has a thickness in a range of 0.3 millimeters to 12.7 millimeters.

53. The fluid delivery system of claim 43, wherein the fluid is selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

54. The fluid delivery system of claim 43, wherein the fluid is selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

55. The fluid delivery system of claim 43, wherein each cell of the matrix of rupturable cells includes a marker to indicate a position whereupon a force is required to rupture one of the cells.

56. The fluid delivery system of claim 43, wherein the surface contact layer includes a scrubbing surface.

57. The fluid delivery system of claim 43, wherein the surface contact layer comprises an intrinsically abrasive material or a material rendered abrasive or additionally abrasive by the inclusion of substances selected from the group consisting of metallic particles, minerals, plastics, and mixtures thereof.

58. The fluid delivery system of claim 43, wherein the fluid delivery system is configured as a flexible sheet.

59. The fluid delivery system of claim 58, wherein the flexible sheet includes lines of material weakness for separating segments of the flexible sheet without rupturing any of the cells of the matrix of rupturable cells.

60. The fluid delivery system of claim 59, wherein the lines of material weakness comprises perforations.

61. The fluid delivery system of claim 43, wherein a volume of the fluid confined within each cell of the matrix of rupturable cells is in a range of 0.1 milliliters to 10 milliliters.

62. The fluid delivery system of claim 43, wherein a diameter of each cell of the matrix of rupturable cells is in a range of 1.0 millimeters to 25 millimeters.

63. The fluid delivery system of claim 43, wherein a space between each cell of the matrix of rupturable cells is in a range of 1 millimeter to 8 millimeters.

64. The fluid delivery system of claim 43, wherein each cell of the matrix of rupturable cells are uniformly spaced.

65. A fluid delivery system comprising:
a flexible film;
a surface contact layer; and
a plurality of rupturable cells positioned between the flexible film and the surface contact layer, each cell containing a fluid confined within the cell and being absorbed by the surface contact layer when at least one of the plurality of cells is ruptured.

66. The fluid delivery system of claim 65, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

67. The fluid delivery system of claim 65, wherein the fluid comprises quaternary ammonium cations.

68. The fluid delivery system of claim 65, wherein the film is impermeable to the fluid contained therein.

69. The fluid delivery system of claim 65, wherein the film comprises a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.

70. The fluid delivery system of claim 65, wherein the surface contact layer is a fibrous material.

71. The fluid delivery system of claim 65, wherein the surface contact layer comprises a material selected from the group consisting of woven or non-woven polyethylene, polypropylene, cotton, polyester, polyamide, polyurethane, wool, sponge, and mixtures thereof.

72. The fluid delivery system of claim 65, wherein the surface contact layer has a thickness in a range of 0.3 millimeters to 12.7 millimeters.

73. The fluid delivery system of claim 65, wherein the plurality of cells comprise polyolefin.

74. The fluid delivery system of claim 65, wherein the fluid is selected from the group consisting of institutional, industrial, commercial and/or consumer cleaners, disinfectants and sanitizers, degreasers, tarnish removers, paint removers, nail polish removers, surface strippers and cleaners, insect repellents, edible materials, antiperspirants, deodorants, cleansers and other skin care fluids, topical antiseptics and antibiotics, sunscreen, and mixtures and combinations thereof.

75. The fluid delivery system of claim 65, wherein the fluid is selected from the group consisting of acetone and other ketones, ethyl and other alcohols, ethyl acetate, butyl acetate, cetyl acetate, propylene carbonate, ethylene carbonate, polyalkylene glycols, glycerin and its esters, petroleum oils, natural oils, and mixtures thereof, selected such that said fluid is inert to and impenetrable through any selected cellular matrix.

76. The fluid delivery system of claim 65, wherein the film includes a marker to indicate a position whereupon a force is required to rupture one of the plurality of cells.

77. The fluid delivery system of claim 65, wherein the surface contact layer includes a scrubbing surface.

78. The fluid delivery system of claim 65, wherein the surface contact layer comprises an intrinsically abrasive material or a material rendered abrasive or additionally abrasive by the inclusion of substances selected from the group consisting of metallic particles, minerals, plastics, and mixtures thereof.

79. The fluid delivery system of claim 65, wherein the fluid delivery system is configured as a flexible sheet.

80. The fluid delivery system of claim 79, wherein the flexible sheet includes lines of material weakness for separating segments of the flexible sheet without rupturing any of the plurality of cells.

81. The fluid delivery system of claim 80, wherein the lines of material weakness comprises perforations.

82. The fluid delivery system of claim 65 further comprising an absorbent layer adjacent to the plurality of rupturable cells.

83. The fluid delivery system of claim 65, wherein a volume of the fluid confined within each of the plurality of cells is in a range of 0.1 milliliters to 10 milliliters.

84. The fluid delivery system of claim 65, wherein a diameter of each of the plurality of cells is in a range of 1.0 millimeters to 25 millimeters.

85. The fluid delivery system of claim 65, wherein a space between each of the plurality of cells is in a range of 1 millimeter to 8 millimeters.

86. The fluid delivery system of claim 65, wherein each of the plurality of cells are uniformly spaced.

87. The fluid delivery system of claim 65, wherein each of the plurality of cells are arranged in a matrix.

88. A method of manufacturing a fluid delivery system, the method comprising:
(a) bonding a surface contact layer sheet to a side of a sheet of cells;
(b) creating an opening in individual cells using a needle;
(c) injecting a fluid through the opening in individual cells using the needle; and
(d) removing the needle from the opening in each injected cell such that the opening closes, thereby preventing escape of the fluid that is contained.

89. The method of claim 88, wherein the needle is a heated needle.

90. The method of claim 89, wherein step (b) further comprises passing the heated needle though the surface contact layer sheet.

91. The method of claim 89, wherein the heated needle is a single needle.

92. The method of claim 89 wherein:
step (b) comprises creating an opening in the individual cells using one heated needle per cell of a matrix of heated needles;
step (c) comprises injecting a fluid through the opening in individual cells using one heated needle of the matrix of heated needles per cell; and
step (d) comprises removing the heated needle of the matrix of heated needles from the opening in each injected cell wherein heat from the heated needle of the matrix of heated needles closes the opening, thereby preventing escape of the fluid that is contained.

93. The method of claim 88, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

94. The method of claim 88, wherein the fluid comprises quaternary ammonium cations.

95. A method of manufacturing a fluid delivery system, the method comprising:
(a) bonding a first sheet of a flexible material to a second sheet of a flexible material to form a matrix of cells;
(b) bonding a surface contact layer sheet to the second sheet;
(c) creating an opening in individual cells using a needle;
(d) injecting a fluid through the opening in individual cells using the needle; and
(e) removing the needle from the opening in each injected cell such that the opening closes, thereby preventing escape of the fluid that is contained.

96. The method of claim 95, wherein the needle is a heated needle.

97. The method of claim 96, wherein step (c) further comprises passing the heated needle though the surface contact layer sheet.

98. The method of claim 96, wherein the heated needle is a single needle.

99. The method of claim 96, wherein:
step (c) comprises creating an opening in individual cells using one heated needle per cell of a matrix of heated needles;
step (d) comprises injecting a fluid through the opening in individual cells using one heated needle per cell of the matrix of heated needles; and
step (e) comprises removing the heated needle of the matrix of heated needles from the opening in each injected cell wherein heat from the heated needle of the matrix of heated needles closes the opening thereby preventing escape of the fluid that is contained.

100. The method of claim 95, wherein the flexible material is thermoplastic.

101. The method of claim 95, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

102. The method of claim 95, wherein the fluid comprises quaternary ammonium cations.

103. A method of manufacturing a fluid delivery system, the method comprising:
(a) providing a matrix of rupturable cells, wherein the matrix of rupturable cells comprises a foam; and
(b) introducing a fluid under a pressure into the matrix such that at least a portion of the cells contains the fluid.

104. The method of claim 103, wherein:
the pressure is uniform across a surface of the matrix.

105. The fluid delivery system of claim 103, wherein introducing the fluid under pressure includes inserting a heated needle into a cell of the matrix of rupturable cells.

106. The method of claim 103, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

107. The method of claim 103, wherein the fluid comprises quaternary ammonium cations.

108. A method of manufacturing a fluid delivery system, the method comprising:
(a) providing a first film and a second film, at least the second film having curved sides that define a plurality of wells in the second film;
(b) introducing a fluid into each of the plurality of wells;
(c) laminating the first film to the second film such that the fluid remains contained within each cell of a plurality of cells created by the first film and the plurality of wells; and
(d) bonding a surface contact layer sheet to one side of the laminated films containing the fluid within each cell of the plurality of cells.

109. The method of claim 108, wherein the fluid includes at least one of: quaternary ammonium cations, isopropyl alcohol, hydrogen peroxide, a phenolic solution, tetraacetylethylenediamine with a suitable peroxygen chemical, sodium hypochlorite, octanoic acid, iodine, and sodium dichloroisocyanurate.

110. The method of claim 108, wherein the fluid comprises quaternary ammonium cations.

111. The method of claim 108 wherein the fluid is introduced into the plurality of wells in liquid, gel, or similar form.

112. The method of claim 108 wherein the fluid is introduced into each well of the plurality of wells in the form of an individual capsule containing the fluid.

113. The method of claim 113 wherein the fluid contained in any capsule in a plurality of capsules in the plurality of wells may be identical to or may differ from the fluid contained in any other capsules in the plurality of capsules.

114. The method of claim 108, wherein the first film and the second film and any individual fluid encapsulant introduced into the plurality of wells each comprise a polymeric material selected from the group consisting of polyacrylics, polyesters, polyolefins, polyoxymethylenes, polystyrenes, polyamides, poly(vinyl acetates), poly(vinyl halides), polyurethanes, silicones, thermoplastic elastomers, thermoset elastomers, copolymers, and mixtures thereof.
